(19) United States
(12) Patent Application Publication
(10) Pub. No.: US 2006/0093310 A1
(43) Pub. Date: May 4, 2006

(54) Device for directly playing multiple external audio and video source of computer

(76) Inventor: Tsung-Yung Hung, Taipei (TW)

Correspondence Address: LIN & ASSOCIATES INTELLECTUAL PROPERTY, P.O. BOX 2339, SARATOGA, CA, 95070-0339, US

(21) Appl. No.: 10/978,069

(22) Filed: Oct. 30, 2004

(51) Int. Cl. H04N 5/76; H04N 11/00; H04N 7/00

(52) U.S. Cl. 386/46; 348/552

(57) ABSTRACT

A device built in a computer for directly playing multiple external AV sources without powering on the computer is provided. An AV signal from one of these external sources is presented on the computer's image display device (such as LCD) and audio device (such as speakers). The AV signal could also be presented on external video devices (such as TV, projector) and audio devices (such as stereo) via the computer's built-in video and audio output interfaces. When the computer is connected to multiple external AV sources, the AV signals from these sources could be presented sequentially in full screen, or they could be presented simultaneously in a split-screen fashion. The device could be controlled by control buttons located on the computer's casing or by a remote control.

### BACKGROUND OF THE INVENTION

1. Field of the Invention

The present invention generally relates to audio and video (AV) playing devices and, more particularly, to the devices built in a computer that can directly play AV signals from multiple external AV sources connected to the computer without powering on the computer.

2. The Prior Arts

Recently more and more computers are equipped with cameras and interfaces for receiving audio and video (AV) signals from TVs, video recording machines, etc. As such, computers have evolved from a number crunching device to a multimedia center capable of playing these AV signals.

To play these externally input AV signals, a computer first has to be powered on and its operating system has to be booted up. Then, a user activates the appropriate playing program via the computer's human-machine interface (such as display, keyboard, and mouse). The user then can view and listen to the content of the AV signals on the computer's display and through its speakers. This is a lengthy and time-consuming process. In addition, when finishing viewing and listening to the AV signals, the user has to follow similar lengthy process to shut down the computer. Therefore, a need for turning computers into home appliances that can be turned on and off instantly has arisen.

In addition, a computer is now capable of receiving inputs from multiple external AV sources. For example, a computer could have two sets of AV input terminals: one is connected to the AV output of a video recording machine; and the other one is connected to the AV output of a V8 camcorder. If these AV signals can be directly played from these external AV sources without the lengthy computer power-on procedure, valuable time can be saved and computers would be become a convenient AV playing device, saving the cost for purchasing additional AV equipment. Besides, as notebook computers are gaining popularity, by equipping notebook computers with such capability of directly playing the external AV signals, notebook computers would become mobile media centers, making such a capability even more powerful.

### SUMMARY OF THE INVENTION

Accordingly, a major objective of the present invention is to provide a device built in a computer capable of directly playing AV signals input from multiple external AV sources connected to the computer without powering on the computer.

The device draws its power from the computer's power supply. If the computer (such as a notebook computer) has a battery, the device could also draw its power from the battery, if the computer's power supply is not able to function (for example, when there is a black-out or when the power cord is not plugged in).

The external AV sources are connected to the computer's built-in AV input interfaces via appropriate cabling. Some of these AV input interfaces have only video input terminals (i.e., there is no audio input) and some other AV input interfaces have both video and audio input terminals (i.e., there are both video and audio inputs). In addition, depending on the types of the AV input interfaces, the AV input signals could be analog signals (such as those via a video-in terminal) or digital signals (such as those via a DVI port). The device of the present invention also supports digital AV sources via USB and 1394 interfaces (such as a web cam).

The AV signals played by the device could be presented on the computer's display (such as the built-in LCD display of a notebook computer, or an external display connected to the computer via a VGA cable) and speakers. The AV signals could also be presented on a TV and/or a stereo connected to the computer via the computer's video output interface (such as the video-out terminal) and audio output interface (such as the earphone terminal, line-out terminal), if these interfaces are available from the computer.

When there are two or more external AV sources connected, the device provides a number of presentation modes. One is a round-robin mode. In this mode, the device starts from the playing of an input AV signal, switches to play another input AV signal after an interval, and switches to play still another input AV signal, and so on. Another one is a split-screen mode. In this mode, the device integrates all input AV signals in a single screen but splits the screen into multiple non-overlapping regions, each of which is for playing an input AV signal respectively. A user could decide how the screen is split (such as 4-region, 9-region, 16-region, etc.) and each region's corresponding input AV signal at any time. Still another is an overlapping-window mode. In this mode, one of the external AV sources is designated as the master source dynamically. The video signal of the AV signal from the master source is always played in a full screen. The audio signal of the AV signal is also always played on the audio device of the computer. As to the rest of the AV signals, their video signals are played in a round-robin mode within a smaller window overlapping on the master source's full screen.

The device provides multiple control buttons on the computer's casing as the device's human-machine interface. The device could also provide a remote control to operate the device from a distance via an air interface (such as infrared or Bluetooth protocol). Both the remote control and the computer casing could further have a small display (such as LEDs or LCD display) for showing operation status of the device.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic diagram of a common computer's internal structure.

FIG. 2 is a schematic diagram of a computer's internal structure according to the present invention.

FIGS. 3a, 3b, 3c are schematic diagrams showing three types of screen splitting on a display according to the present invention.

FIG. 4 is a schematic diagram showing the overlapping-window presentation mode on a display according to the present invention.

### DETAILED DESCRIPTION OF THE PREFERRED EMBODIMENTS

In the following, detailed description along with the accompanied drawings is given to better explain preferred embodiments of the present invention. Please be noted that, in the accompanied drawings, some parts are not drawn to scale or are somewhat exaggerated, so that people skilled in the art can better understand the principles of the present invention.

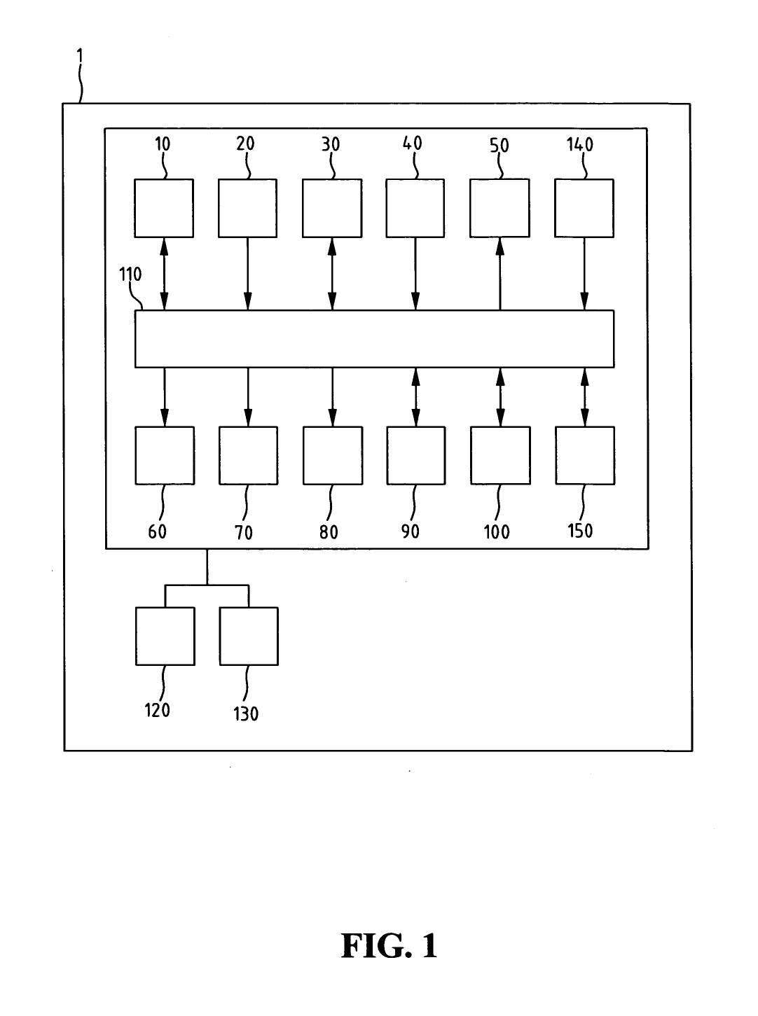

FIG. 1 is a schematic diagram of a common computer's internal structure. As shown in FIG. 1, the computer 1 comprises a processor 10 for handling the computer 1's major computational work. The read-only memory (ROM) 20 contains the BIOS firmware (not shown) providing the lowest level control functions for the computer 1. The random-access memory (RAM) 30 is for storing the codes, variables, and user data generated during the computational process of the operating system and application programs. The input devices 40 such as keyboard, mouse, track-ball are for accepting user input. The image display device 50 is the display connected to the computer 1's VGA port (not shown). The image display device 50 could be a built-in LCD display (if computer 1 is a notebook computer) or a LCD display, a CRT display, or a projector (not shown) connected via a VGA cable. The audio device 60 is the computer 1's built-in speakers or other loudspeakers. What is depicted in FIG. 1 is a notebook computer.

The video output interfaces 70 are for delivering the computer 1's video signal to external video devices. The video output interfaces 70 include, but not limited to, the video-out terminal, S-video terminal, RGB terminals, DVI port, and a second VGA port, etc. These interfaces could be used to connect devices such as (but not limited to) a TV, video recording machine, or projector, etc. The audio output interfaces 80 are for delivering the computer 1's audio signal to external audio devices. The audio output interfaces 80 include, but not limited to, the line-out terminal, earphone terminal, etc. These interfaces could be used to connect devices such as, but not limited to, a stereo, audio recording machine, etc.

The fixed storage devices 90 are storage devices fixedly installed inside the computer 1 such as hard disk drive, floppy disk drive, read-only laser disk drive (for reading CD-ROM and DVD-ROM disks), and read-writable laser disk drive (for accessing CD-RW, DVD-RW, DVD+RW disks). In addition, the computer 1 also contains non-fixed storage devices 100. These external storage devices (such as USB flash drive, USB-based external hard disk, etc.) are connected to the computer 1 via USB, 1394, parallel port, or serial ports, etc.

External AV sources are connected to the computer 1's AV input interfaces 140 via appropriate cabling. Some of these AV input interfaces 140 have only video input terminals (i.e., there is no audio input). Some other AV input interfaces 140 have both video and audio input terminals (i.e., there are both video and audio inputs). The video input terminals include, but not limited to, video-in terminal, S-video terminal, RGB terminals, DVI port, etc. The audio input terminals include, but not limited to, line-in terminal, microphone terminal, etc. The device of the present invention also supports AV sources (such as web cam) connected to the computer 1's built-in I/O interfaces 150 (such as 1394 and USB).

The aforementioned parts of the computer 1 are all connected to a bus 110 for exchanging all sorts of data. Please be noted that quite a few details are omitted in FIG. 1 such as the chipsets, I/O controllers, and communication interfaces (such as LAN ports). However, these details are not of much help in explaining the principles behind the present invention and, therefore, they are omitted here for simplicity sake.

The power supply 120 provides the required electrical power to all the aforementioned parts. The power supply 120 receives an AC voltage from the mains and converts it into various DC voltages required by the aforementioned parts of the computer 1. If the computer 1 is a notebook computer, it could also contain a battery 130 for continuously supplying power when there is a black-out or when the AC voltage from the mains is not available. The electrical connections from the power supply 120 and the battery 130 to the various parts of the computer 1 are not depicted in FIG. 1.

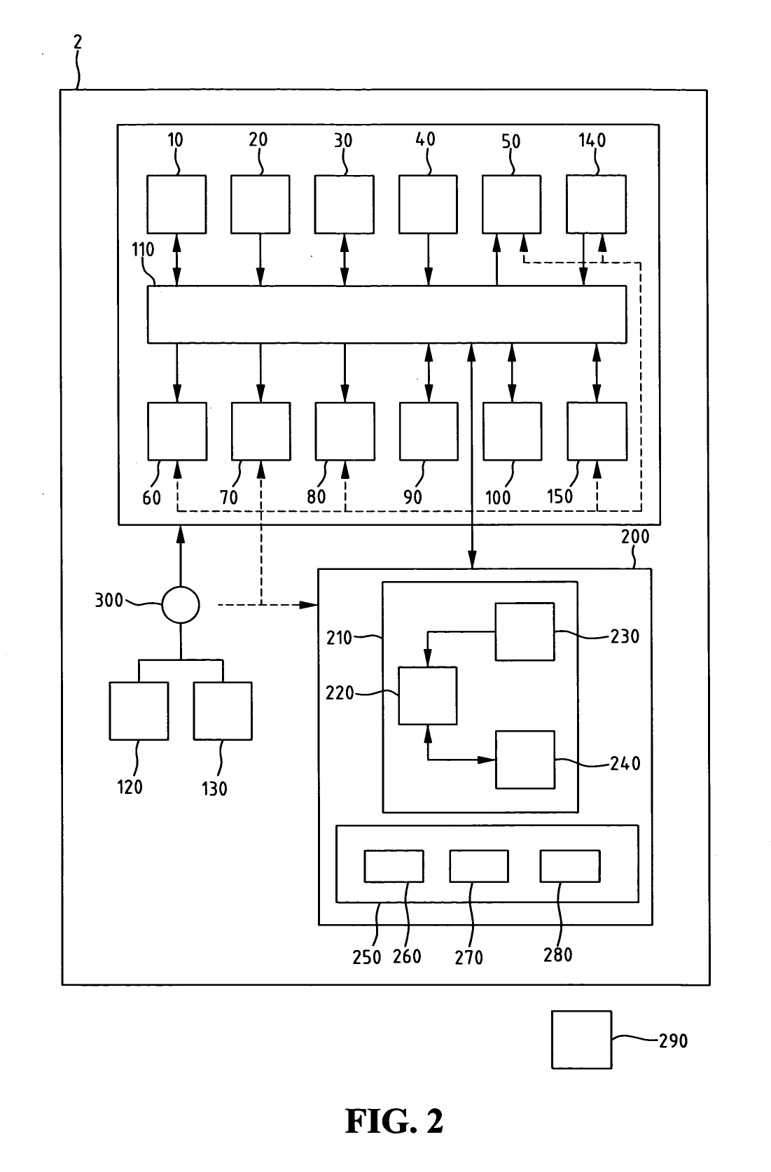

FIG. 2 is a schematic diagram of a computer's internal structure according to the present invention (FIG. 2 also uses a notebook computer as an example). Compared to what is depicted in FIG. 1, the computer 2 according to the present invention has an additional AV processing module 200, which is connected to the bus 110 as well. Through the bus 110, the AV processing module 200 is able to receive video and/or audio signals from the AV input interfaces 140 and the I/O interfaces 150. The AV processing module 200 then processes these signals and, also through the bus 110, the result of the AV processing module 200 is played on the image display device 50 and the audio device 60, or on the external AV equipment connected to the video output interface 70 and the audio output interface 80.

The AV processing module 200 comprises a processing chipset 210 and a control interface 250. The processing chipset 210 in turn comprises a microprocessor 220 having AV processing and analog-digital conversion capabilities, a ROM 230, and a RAM 240. The microprocessor 220 receives the AV signals from the AV input interfaces 140 and the I/O interfaces 150, processes them according to a user-specified presentation mode, and play the AV signals on the image display device 50 and the audio device 60, or on the external AV equipment via the video and audio output interfaces 70, 80. The ROM 230 contains the firmware required by the microprocessor 220 for carrying out various tasks. The RAM 240 provides the temporary storage space required by the microprocessor 220 during its operations.

When there is a single external AV source connected, the AV processing module 200 directly plays the AV signal from the external AV source on and in a format appropriate to the image display device 50 and the audio device 60, or on and in a format appropriate to the external AV equipment connected to the video output interface 70 and audio output interface 80.

When there are two or more external AV sources connected, the AV processing module 200 provides a number of presentation modes. The simplest one is to play the AV signal from a specific AV source designated by a user. Later, at any time, the user can dynamically switches to play AV signals from other AV sources.

One of the presentation modes is the so-called round-robin mode. In this mode, the AV processing module 200 starts the playing of an AV signal from an external AV source. Then, after a period of time, the AV processing module 200 automatically switches to play the AV signal from another AV source. Again, after another period of time, the AV processing module 200 switches to play the AV signal from still another AV source. The pattern continues until the AV signals from all external AV sources are played. The AV processing module 200 then starts again to play the AV signal from the first AV source and the whole process is repeated again and again. The period of time for playing an AV signal could be pre-determined or it could be specified by a user dynamically. During the round-robin process, a user could temporarily pause the automatic AV source switching and let the playing of an AV signal from a specific AV source continue for an indefinite period of time. Afterward the user could resume the round-robin process at any time.

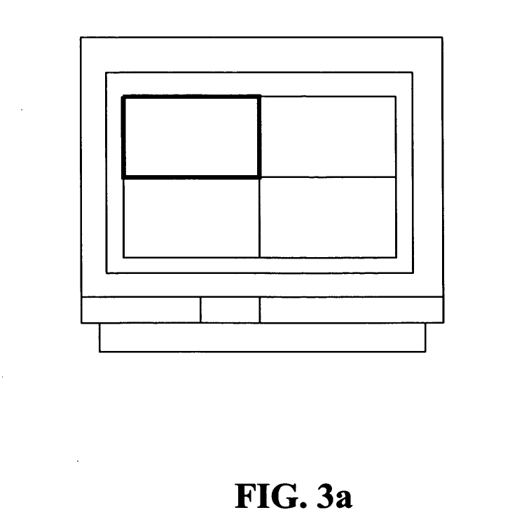

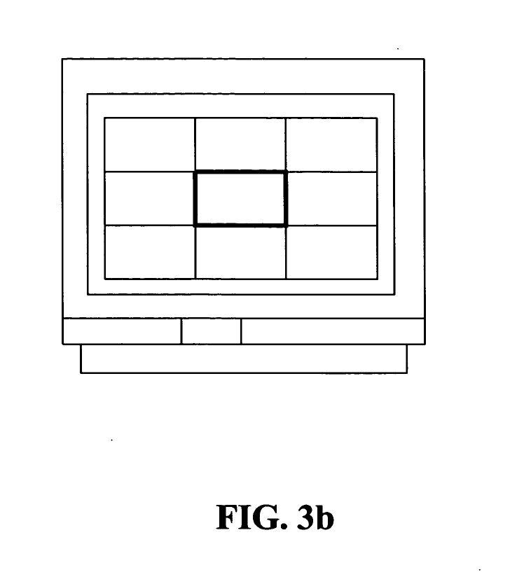

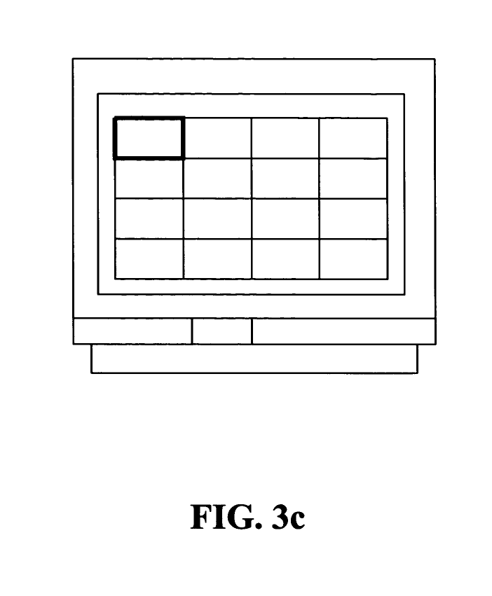

Another presentation mode is the so called split-screen mode. In this mode, the AV processing module 200 integrates the video signals from all AV sources into a single screen appropriate for playing on the image display device 50 or on a video display connected to a video output interface 70. The AV processing module 200 splits the screen into a number of non-overlapping regions. Each of the video signals from the external AV sources is played witin one of the regions respectively. A user could select the desired screen splitting from a number of pre-determined splitting styles (such as 4-region split, 9-region split, 16-region split, etc.) Besides choosing the splitting style, a user could also dynamically specify what video signal is played in a specific region. In addition, one of regions could be designated as a mater region. The audio signal delivered to the audio device 60 or through an audio output interface 80 of the computer 2 is always from the AV signal played within the master region. Therefore, even though there are multiple video signals played simultaneously in a screen, the computer 2 plays the audio signal from the external AV source of the master region only. FIGS. 3a, 3b, 3c are schematic diagrams showing three types of screen splitting on a display according to the present invention. As shown in FIGS. 3a, 3b, 3c, the region having a thicker boarder is the master region. The master region could also be dynamically specified by a user.

In an embodiment of the present invention, when the number of screen regions is less than the number of external AV sources connected, i.e. a single screen is not enough for playing all input AV signals, a user could select a presentation mode which is an integration of the split-screen and round-robin modes. In this mode, using 4-region screen splitting as an example, the AV processing module 200 plays four video signals in four regions (as shown in FIG. 3a) of a screen at a time. After a period of time, another four video signals are played again, just like the round-robin mode. All the functionalities of the round-robin and split-screen modes (such as user-defined interval, pause/resume, etc.) are also available in this mode.

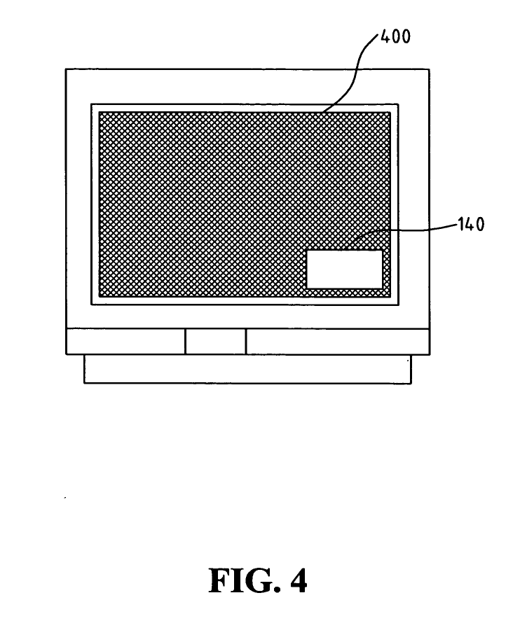

Still another presentation mode is the so-called overlapping-window mode. FIG. 4 is a schematic diagram showing the overlapping-window presentation mode on a display according to the present invention. As shown in FIG. 4, one of the AV sources could be dynamically designated as the master source. The video signal from the master source is played in a full screen 400. The audio signal played by the computer 2's audio device 60 or audio output interface 80 is also from the master source. The video signals from the rest of the AV sources are played sequentially as in the round-robin mode within a smaller window 410 overlapping on the full screen of the master source. The functionalities of the round-robin mode (such as the user-defined interval, pause/resume, etc.) are also available in this presentation mode. A user could also specify a separate AV source as the master source at any time.

All the aforementioned presentation modes of the AV processing module 200 are controlled by a user via the control interface 250. The control interface 250 comprises a set of control buttons 260 located on the computer 2's casing, through which a user is able to control microprocessor 220's operations. The set of control buttons 260 contains multiple buttons for turning on/off the AV processing module 200's operations (by controlling whether to supply electrical power to the microprocessor 220), selecting the output devices or interfaces, play/stop, pause/resume, selecting the presentation modes (such as round-robin mode, split-screen mode, etc.), switching among the AV sources, switching among the screen regions, switching between the full screen and the overlapping window, switching among different settings of a specific presentation mode (for example, switching among 4-region, 9-region, and 16-region screen splitting under the split-screen mode, or switching among a number of pre-determined playing intervals), etc.

The control interface 250 could further comprise a small display 270 (such as a LCD screen for showing 10×2 characters) besides the set of control buttons 260. During the operations of the control interface 250, the display 270 provides relevant operation status to a user, such as the name of the AV source being played, error messages, etc. The control interface 250 could also provide a remote control reception interface 280 for taking commands to the AV processing module 200 from a remote control 290 via infrared or Bluetooth protocol. The remote control 290 basically possesses a same set of control buttons as 260. The remote control 290 could also have a small display for showing operation status.

A major feature of the present invention is that AV signals could be played even when the computer 2 is not powered on. The present invention therefore provides a specially designed switch 300 located on the electrical path from the power supply 120 and the battery 130 to the various parts of the computer 2 and the AV processing module 200. The switch 300 is coupled to the power switch (not shown) of the computer 2. When the power switch of the computer 2 is turned on, the switch 300 would be set to a state so that electrical power is delivered to the various parts of the computer 2, but not to the AV processing module 200. As such, when the computer 2 is running, the AV processing module 200 is unable to function due to the lack of electrical power. However, when the computer 2's power switch is off, the switch 300 is set to another state so that the electrical power is delivered to the AV processing module 200, but not to the other parts of the computer 2. In other words, the AV processing module 200 and the other parts of the computer 2 cannot function at the same time. Please be noted that, during the operation of the AV processing module 200, the AV processing module 200 needs to work with the following parts of the computer 2: the bus 110, video output interfaces 70, audio output interfaces 80, image display device 50, audio device 60, AV input interfaces 140, and I/O interfaces 150. Therefore, when the AV processing module 200 is supplied with electrical power, there are other electrical paths from the power supply 120 and the battery 130 to the aforementioned parts (shown as dotted lines in FIG. 2), so that these parts are still functioning even though the computer 2 is not powered on. During the operation of the AV processing module 200, if the computer 2's power switch is turned on, the AV processing module 200 would stop immediately as its electrical power is interrupted.

The AV processing module 200 of the present invention would automatically processes the input AV signals and determines the appropriate playing format without user intervention, based on the characteristics of the video output interfaces 70, audio output interfaces 80, image display device 50, and audio device 60.

A basic operation flow of the present invention is as follows. Initially, the power switch of the computer 2 is off. At this moment, the AV processing module 200 is supplied with electrical power. Then the control buttons 260 on the computer 2's casing or the remote control 290 is used to turn on the microprocessor 220, causing it to enter a stand-by mode. The external AV sources are connected to the AV input interfaces 140 and the I/O interfaces 150 via appropriate cables. The control buttons 260 or the remote control 290 is used again to select the output devices or interfaces, the presentation mode, and the relevant settings of the presentation mode. Then a play button within the control buttons 260 or on the remote control 290 is used to start the playing. Other operation flows could be easily understood and, therefore, their description is omitted here.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A device built in a computer capable of directly playing AV signals input from at least an external AV source connected to said computer without powering on said computer, comprising:
an AV processing module inside said computer connected to a bus of said computer through which data is exchanged with other parts of said computer, said AV processing module receiving at least an AV signal from at least an external AV source via one of AV input interfaces and I/O interfaces of said computer, processing said AV signal according to a user-specified presentation mode, determining automatically an appropriate playing format, and playing said AV signal via said bus to at least one of said computer's output interfaces and output devices; and
a switching device located on an electrical path through which a power source of said computer supplies electrical power to various parts of said computer and said AV processing module, said switching device coupled with a power switch of said computer so that, when said power switch is turned on, said switching device is set to a state causing said power source to supply electrical power to various parts of said computer other than said AV processing module, and, when said power switch is turned off, said switching device is set to another state causing said power source to supply electrical power only to said AV processing module, said bus, said AV input interfaces, said I/O interfaces, said output interfaces, and said output devices.

2. The device according to claim 1, wherein said output interfaces comprise video output interfaces and audio output interfaces.

3. The device according to claim 1, wherein said output devices comprise an image display device and an audio device.

4. The device according to claim 1, wherein said AV signal comprises a video signal.

5. The device according to claim 1, wherein said AV signal comprises a video signal and an audio signal.

6. The device according to claim 3, wherein said image display device is a display built in said computer.

7. The device according to claim 3, wherein said image display device is an external display connected to said computer via a cable.

8. The device according to claim 3, wherein said audio device is said computer's built-in speakers.

9. The device according to claim 2, wherein said video output interfaces comprise at least one selected from the group comprising video-out terminal, S-video terminal, RGB terminals, DVI port, and a second VGA port.

10. The device according to claim 2, wherein said audio output interfaces comprise at least one selected from the group comprising line-out terminal and earphone terminal.

11. The device according to claim 1, wherein said AV input interfaces comprise at least a video input terminal selected from the group comprising video-in terminal, S-video terminal, RGB terminals, and DVI port.

12. The device according to claim 11, wherein said AV input interfaces further comprise at least an audio input terminal selected from the group comprising line-in terminal and microphone terminal.

13. The device according to claim 1, wherein said I/O interfaces comprise at least one selected from the group comprising USB and 1394.

14. The device according to claim 1, wherein said power source is a power supply built in said computer.

15. The device according to claim 14, wherein said power source further comprises a battery built in said computer providing its stored electrical power when said power supply cannot function.

16. The device according to claim 1, wherein said AV processing module further comprises:
a processing chipset connected to said bus for integrating, processing, and playing input AV signals; and
a control interface providing an user interface for controlling said processing chipset's operations.

17. The device according to claim 16, wherein said processing chipset further comprises:
a microprocessor connected to said bus for receiving at least an AV signal input from said AV input interfaces and said I/O interfaces, integrating and processing said AV signal according to said presentation mode, and playing said AV signal on at least one of said output devices and output interfaces;
a ROM storing a firmware required by said microprocessor to carry out various tasks; and
a RAM providing temporary storage space during said microprocessor's computing process.

18. The device according to claim 16, wherein said control interface further comprises a set of control buttons located on said computer's casing providing at least the following functions: turning on/off said AV processing module, selecting at least one of said output devices and interfaces for playing said AV signal, playing/stopping, pausing/resuming, selecting a presentation mode, switching among a plurality of AV signals, switching among a plurality of regions in a screen, switching among a plurality of settings of said presentation mode.

19. The device according to claim 18, wherein said control interface further comprises a display on said casing of said computer besides said set of control buttons for showing operation status of said AV processing module to a user during said AV processing module's operation process.

20. The device according to claim 18, wherein said control interface further comprises a remote control reception interface on said casing of said computer and a remote control providing at least a same set of functions as those provided by said set of control buttons, through which said AV processing module is controlled in a distance via a form of wireless communication.

21. The device according to claim 20, wherein said remote control further comprises a display for showing operation status.

22. The device according to claim 1, wherein said presentation mode is to play a single AV signal selected from a plurality of input AV signals at any time by a user during said AV processing module's operation process.

23. The device according to claim 1, wherein said presentation mode is to play a plurality of AV signals automatically, sequentially, and repeatedly in a loop, each of said plurality of AV signals is played for a period of time before switching to a next AV signal, said loop could be paused at any time by a user so that an AV signal currently under play would continue for an indefinite period of time, and said user could resume said loop at any time during said AV processing module's operation process.

24. The device according to claim 23, wherein said period of time is determined by a user through said AV processing module at any time during said AV processing module's operation process.

25. The device according to claim 1, wherein said presentation mode is to integrate a plurality of AV signals simultaneously in a screen and to play each of said plurality of AV signals within one of a plurality of non-overlapping regions of said screen respectively, one of said non-overlapping regions is designated as a master region by a user at any time during said AV processing module's operation process, and said computer always plays an audio signal from an AV signal currently played inside said master region.

26. The device according to claim 25, wherein a user determines how a screen is split into non-overlapping regions by selecting from a plurality of pre-determined screen splitting styles provided by said AV processing module at any time during said AV processing module's operation process.

27. The device according to claim 25, wherein a correspondence between said plurality of AV signals and said plurality of non-overlapping regions is specified by a user at any time during said AV processing module's operation process.

28. The device according to claim 25, wherein one of said plurality of non-overlapping regions is specified as said master region by said user at any time during said AV processing module's operation process.

29. The device according to claim 25, wherein, when the number of non-overlapping regions is less than the number of input AV signals, said plurality of AV signals are integrated into a plurality of screens, each of said AV signals is played within a non-overlapping region in one of said screens, said screens are played automatically, sequentially, and repeatedly in a loop, each of said screens is played for a period of time, said loop could be paused at any time by a user so that a screen of AV signals are played for an indefinite period of time, and said user could resume said loop at any time during said AV processing module's operation process.

30. The device according to claim 29, wherein said period of time is determined by a user through said AV processing module at any time during said AV processing module's operation process.

31. The device according to claim 1, wherein said presentation mode is to play one of a plurality of input AV signals in a full screen, other AV signals are played in a smaller overlapping window over said full screen, and said computer always plays an audio signal of an AV signal played in said full screen.

32. The device according to claim 31, wherein one of said plurality of AV signals is selected to be played in a full screen by a user at any time during said AV processing module's operation process.

33. The device according to claim 31, wherein one of said other AV signals is selected to be played in said overlapping window by a user at any time during said AV processing module's operation process.

34. The device according to claim 31, wherein said other AV signals are played in said smaller overlapping window automatically, sequentially, and repeatedly in a loop, each of said other AV signals is played for a period of time, said loop could be paused at any time by a user so that an AV signal is played for an indefinite period of time, and said user could resume said loop at any time during said AV processing module's operation process.

35. The device according to claim 31, wherein said period of time is determined by a user through said AV processing module at any time during said AV processing module's operation process.
